(19) United States
(12) Patent Application Publication
(10) Pub. No.: US 2022/0212045 A1
(43) Pub. Date: Jul. 7, 2022

(54) EXTINGUISHING DEVICE AND EXTINGUISHING METHOD

(71) Applicant: CSI-VERWALTUNGS-GBR, Rheda-Wiedenbrück (DE)

(72) Inventor: Claude VALERIUS, Niederneisen (DE)

(21) Appl. No.: 17/594,794

(22) PCT Filed: May 19, 2020
(86) PCT No.: PCT/EP2020/063900

§ 371 Date: Oct. 29, 2021

(30) Foreign Application Priority Data
May 20, 2019 (DE) 20 2019 002 217.1

(51) Int. Cl. A62C 25/00

(52) U.S. Cl. CPC A62C 25/00

(57) ABSTRACT

An extinguishing device and extinguishing method, including a dispensing device and an extinguishing agent supply. The dispensing device has a pump device and a nozzle device in order to dispense an extinguishing agent. The extinguishing device features the extinguishing agent supply including at least one bag device having a flexible wall.

The present invention relates to an extinguishing device, which comprises at least one dispensing device and at least one extinguishing agent supply. The dispensing device comprises at least one pump device and at least one nozzle device in order to dispense the extinguishing agent. The present invention also relates to an extinguishing method having such an extinguishing device.

Extinguishing devices of this type are used, for example, in fire extinguishers, which in particular can be manually operated and are portable. Furthermore, such fire extinguishing devices can also, however, be used in fully automatic and/or semi-automatic extinguishing systems. These extinguishing systems can be provided, above all in a compact manner, in particular at locations at risk of fire, such as cooking appliances, stoves in mobile homes, mobile cooking points, chemical energy storage devices, such as batteries, in laboratories, for example directly on a fume cupboard. However, they can also be very advantageously used in land vehicles, such as cars, lorries, buses, water vehicles such as ships or boats and aircraft such as aeroplanes, helicopters, hot air or gas balloons or airships. Furthermore, it is also preferably possible to use such an extinguishing device in a (fully) automatic extinguishing system in commercial, industrial or also residential properties with large usable areas.

Various operating principles of extinguishing devices have become known from the prior art.

In particular, such extinguishing systems where the extinguishing agent is discharged by means of a mechanical energy storage device have become known. Such mechanical energy storage devices can be provided, for example, by spring systems or spring-like systems, such as flexibly stretchable bag-like materials. The extinguishing agent is discharged by relaxing the stretchable materials.

In other extinguishing systems, propellant and/or compressed gases are used to dispense the extinguishing agent from a supply through a nozzle. In this case, the extinguishing agent is discharged by successive expansion of the gas which is under high pressure. Such systems are used above all for hand-held fire extinguishers.

A disadvantage of such extinguishing systems is in particular that the volume flow of the discharged extinguishing agent depends directly on a state of charge of the mechanical energy storage device. The volume flow of the discharged extinguishing agent decreases as the mechanical energy storage device gets less charged. As a result, it cannot be ensured that the entire extinguishing agent of the extinguishing agent supply effectively contributes to an extinguishing operation.

Moreover, the mechanical energy storage devices pose a high risk of explosion and injury in a charged state. In the case of a potential malfunction or potential damage caused by use of force, the energy storage device may be damaged such that the extinguishing agent is discharged in an uncontrolled manner. Splintered parts of the extinguishing device may be slung uncontrollably into the surroundings, injuring people or damaging objects. Strong shocks and impacts should therefore often be avoided. The mechanical energy storage devices and their fill levels or charge states must be regularly maintained and checked. In addition, systems powered by compressed gas must not be used in aviation, for example.

Moreover, such systems where an extinguishing agent is sucked out of a container and discharged by means of a pump have in particular become known. Such systems have a riser tube, by means of which the extinguishing agent is conveyed against the force of gravity and discharged through a nozzle. The extinguishing agent is discharged with a uniform volume flow regardless of the fill level by means of the mostly electric pump.

However, it is particularly disadvantageous in these systems that such suction systems are dependent on the orientation of the riser tube and the position of the extinguishing agent supply relative to the pump. The extinguishing agent can only be sucked in against gravity through the riser tube and discharged. This particularly restricts possible installation positions, the required installation space and application options. For example, the safe function of such an extinguishing device, which is permanently installed in a mobile home or other vehicle, cannot be guaranteed. If the vehicle falls on its side in an accident, its function can no longer be safely guaranteed due to the change in orientation of the device and change in position of the components to one another.

It is therefore the object of the present invention to provide an extinguishing device and an extinguishing method that at least partly eliminate the abovementioned disadvantages and in particular enable reliable use in all areas.

The object is achieved by means of an extinguishing device having the features of Claim 1 and a method having the features of Claim 19. Preferred embodiments and configurations of the invention result from the general description and description of the exemplary embodiments.

The extinguishing device according to the invention comprises at least one dispensing device and at least one extinguishing agent supply. The dispensing device comprises at least one pump device and at least one nozzle device in order to dispense at least one extinguishing agent from the extinguishing agent supply. According to the invention, the extinguishing agent supply comprises at least one bag device, in which the extinguishing agent is stored, wherein the bag device has a flexible wall at least in sections.

The wall of the bag device is at least partially and in particular completely flexible and not rigid. In this way, the extinguishing agent volume discharged in an extinguishing operation can be compensated for by a change in the volume of the bag device and, more precisely, by deforming the bag device.

According to the present application, a nozzle device refers in particular to at least one change in the fluidic cross-section. This change can be geometrically defined or result from the arrangement of fluidic components and/or component sections in relation to each other. In this way, a nozzle device can be formed, for example, by a tube end or another abrupt change in cross section, through which the extinguishing agent is discharged into the environment.

The pump device advantageously comprises at least one pump. The extinguishing device can also advantageously contain two or more pumps.

According to the present application, the extinguishing agent is present in particular in solid and/or liquid form. The extinguishing agent can also comprise several components, which are mounted separately from one another and are only mixed together during dispensing and/or shortly before dispensing.

The extinguishing device according to the invention has many advantages. One significant advantage is that the device can be used and is functional regardless of the position and/or orientation of the bag device. It is thus particularly advantageous that the extinguishing device is ready for operation and functional even in the case of a change in position and/or orientation. In addition, an orientation and/or position of the bag device does not restrict the required installation space and installation position. Another advantage is that the extinguishing agent is not discharged by propellant or compressed gas or by means of another mechanical energy storage device.

In particular, the pump device guarantees that the extinguishing agent can be discharged with a constant volume flow of the extinguishing agent. In addition, there is no risk of explosion, as with a mechanical energy storage device, where the extinguishing agent is discharged by a compressed and/or propellant gas. This also makes it possible to use it in aviation in particular.

In addition, the extinguishing device is particularly environmentally friendly as a result. Thanks to the small number of parts or components required, the extinguishing device is also cheap to produce and operate and requires little maintenance. Furthermore, the device can also be integrated into other devices in a particularly compact way or arranged and/or mounted directly and variably in a location with a potentially high risk of fire.

In addition, thanks to the design of the extinguishing agent supply and pump device, substantially complete or even complete discharging of the extinguishing agent volume can be achieved.

The fire extinguishing device preferably comprises at least one housing and/or in particular at least one housing device, in which the dispensing device and/or the extinguishing agent supply are at least partially arranged. A housing device preferably comprises at least one housing. Particularly advantageously, the housing is at least partially rigid and inflexible.

In this way, the flexible wall of the bag device can in particular be effectively protected against damage or also external force. In addition, it is thus possible to house all devices of the extinguishing device in a space-saving manner in a common housing made of a preferably light and in particular non-flammable material.

The housing is preferably at least partially cylindrical and/or cuboid in cross section. Moreover, the housing can also have other forms. Thanks to the housing, the extinguishing device can preferably also be used portably and can in particular be used flexibly. The housing preferably comprises at least one handle and/or a handle element for holding, carrying and/or taking with you and/or handling. Attachment elements for directly arranging and/or in particular for screwing onto other objects are preferably also provided on the housing.

Moreover, it is also possible that the housing comprises several sub-housings, in which the individual devices of the extinguishing device are at least partially housed. In particular, the dispensing device and the extinguishing agent supply can be respectively housed in separate sub-housings. In this case, the dispensing device and/or bag device can be respectively at least partially permanently and/or modularly connected to the respective sub-housing or to the entire housing.

In the case of a design with at least one sub-housing, a modular structure is advantageous so that, for example, it is possible to quickly replace a bag device or extinguishing agent supply by means of a coupling and/or a quick-release fastener.

Particularly advantageously, a ventilation opening is present in the housing of the extinguishing device in order to enable permanent pressure equalization between the inside of the housing and the surroundings. In this way, a slight negative pressure is created advantageously only briefly when the volume of the bag device changes due to the discharged extinguishing agent.

In one advantageous development, the flexible wall of the bag device is not stretchable or only slightly stretchable. In this way, there is virtually always almost ambient pressure inside the bag device when the volume of the bag device changes. The material of the bag device or at least of the flexible wall is advantageously less than 10% stretchable based on a reference measure in the unstretched state. In particular, the material is less than 5% or even particularly preferably less than 2% stretchable. In a particularly advantageous embodiment of the bag device, the material of the bag device is (ideally) unstretchable or not stretchable and flexible. The term “unstretchable” refers here to the property of the material of the bag wall to not be stretchable and in particular to not be stretchable at all.

This preferably effectively prevents at least the bag device functioning at least partially as a mechanical energy storage device and thus influencing the volume flow of the discharged extinguishing agent.

In all embodiments, the bag device is preferably designed or the material is preferably selected in such a way that in the filled state, it withstands an external pressure of up to at least 10 bar, preferably up to at least 7 bar, particularly preferably up to at least 5 bar and in particular up to 1.5 bar or 3.0 bar. As a result, depending on the embodiment, the bag device remains functional e.g. in the event of a rapid increase in pressure, for example in enclosed systems or housings, due to thermal or chemical reactions, and/or other external influences.

In preferred embodiments of the extinguishing device, an intake side of the pump device is operatively connected to the extinguishing agent supply and in particular to the bag device. The discharge side of the pump device is advantageously operatively connected to the nozzle device. In this way, the extinguishing agent can particularly advantageously be sucked directly out of the bag device by the pump device and discharged through the nozzle device. The negative pressure created by the suction is advantageously compensated for by the volume change of the bag device.

In one preferred development of the extinguishing device, the bag device comprises at least one foil bag, which is at least partially mechanically glued, sealed and/or clamped. The foil bags can preferably also be at least partially welded. Foil bags are advantageously particularly cheap to produce. The foil material is in particular only slightly stretchable and is therefore preferably suitable for use in connection with the extinguishing device. Moreover, a foil material is preferably robust and the foil bags are in particular easy to re-fill.

The extinguishing agent supply advantageously comprises two or more bag devices. The bag devices can in particular preferably be at least partially operatively connected to the pump device at the same time. Moreover, the bag devices can be brought into operative connection in particular one after the other, e.g. by switchable valves and/or mixing chambers. In particular, the extinguishing agent supply can also comprise up to 10 or more bag devices. Particularly preferably, the extinguishing device comprises two bag devices.

Depending on the embodiment, preferably different extinguishing agents and/or substances can be stored in several bag devices. In particular, the same extinguishing agent can also be present in the bags. Depending on the embodiment, different extinguishing agents can preferably, however, also be stored, which are discharged in particular depending on the situation identified. In this way, when a fire is detected, for example, a different extinguishing agent can be dispensed than in the case of smoke being detected. An extinguishing agent can also preferably be provided and a subsequently discharged agent, which neutralises the extinguishing agent following the extinguishing process.

In particular, the extinguishing agents contained in the bag devices have at least partially different chemical properties from one another. An extinguishing agent can in this case preferably be optimised for a specific purpose, such as a grease fire, a chemical fire, a paper fire or other types of fires. If several different extinguishing agents are required at a location, they can thus be preferably stored in different bag devices.

In another advantageous development, an extinguishing agent consists at least partially of two or more functional components, which are stored separately from one another in the bag devices of the extinguishing agent supply. An extinguishing agent can thus advantageously be used with several functional components, wherein the functional components are stored in separate bag devices. This can in particular be expedient in the case of chemically active extinguishing agents that should be stored separately from one another. During and/or before dispensing, the functional components can be brought into contact in a targeted manner such that a chemical reaction or chemical activity can be produced.

In one preferred embodiment, a bag device comprises at least one locking element, which is arranged at least partially within the bag device. The locking element is preferably at least partially connected to the bag device. The locking element can advantageously be designed as a grate element, for example. The locking element preferably prevents the flexible wall of the bag unit from being sucked in. Functionally reliable operation is supported by the locking element. The locking element is connected to the bag device in an exchangeable manner in particular via a coupling or else via a valve. Other exchangeable connections are also possible. Moreover, the locking element can also be permanently connected to the bag device. The bag device is connected to the pump device in particular via the locking element. In this case, the pump device can preferably directly suck in through the locking element.

The locking element is advantageously at least partially hollow on the inside and comprises at least one intake opening. The intake opening is in particular preferably operatively connected to the pump device. In a preferred embodiment, the locking element is at least partially designed as a tubular element. The locking element can thus fulfil its function particularly effectively.

In one preferred embodiment, the locking element extends over a substantial part of the bag device. The locking element can thus advantageously act at any point of the bag device. In addition, this in particular assists with completely and smoothly emptying the bag unit.

The dispensing device advantageously comprises at least one magnetic valve or one valve device. The valve device can preferably also be designed as a mechanically or hydraulically controllable valve. The dispensing device also in particular comprises a mixing chamber. The at least one magnetic valve, the valve device and/or the mixing chamber are preferably operatively connected to the pump device and the extinguishing agent supply.

The magnetic valve can advantageously achieve particularly fast control of the extinguishing agent supply for dispensing the distinguishing agent. Thanks to the mixing chamber, it is also possible to mix, intermix and/or chemically activate several extinguishing agents or also functional components of an extinguishing agent prior to dispensing. The volume flows can advantageously be mixed or controlled by adjusting fluidic cross sections. In the case of a mixer, different flow cross sections or bag devices can preferably be released via magnetic valves.

The dispensing device expediently comprises at least one control device. The dispensing device preferably contains at least one electrical component. In particular, the dispensing device has at least one electrical circuit. The control device advantageously comprises at least one electrical component and/or at least one electrical circuit. In particular, the control device comprises at least one switch and/or one switching element. The switch and/or switching element are preferably suitable for manually initiating and/or continuing an extinguishing operation.

The control device can in particular also contain electronic components such as microprocessors. Advantageously, the control device can thus preferably be used in order to control the function of the dispensing device in a complex manner. The control device particularly preferably controls the function of the pump device. It is therefore possible, for example, to dispense the extinguishing agent in a targeted manner with a time delay and/or at short dispensing intervals. Moreover, different extinguishing programmes and/or control characteristics are also possible.

In addition, the control device can preferably be used to control the mixing in an in particular existing mixing chamber and/or the dispensing of different existing extinguishing agents. The control device can be connected to the electrical mains and/or at least partially electrically operated. A mechanical version of the control device is also conceivable.

By means of a control device, one and/or more extinguishing agents and/or other substances can preferably also be sequentially dispensed from an extinguishing agent supply and/or several extinguishing agent supplies. For example, in this way, depending on the embodiment, a further medium can be dispensed following dispensing of an extinguishing agent via targeted control in order, for example, to neutralise the reaction products at the location of the fire. In particular, milk of lime can be dispensed, for example, to neutralise acids and/or acidic liquids and substances.

In particular, the extinguishing device comprises at least one energy storage device. The extinguishing device advantageously comprises in particular a power generation device. Electrical equipment of the extinguishing device can thus advantageously be supplied with electrical power.

An energy storage device can, for example, be designed as a battery, in particular having a long life and/or at least one (re)chargeable battery or at least one accumulator. Moreover, it is also preferably possible that solar elements, wind turbines, thermal and/or mechanical systems are used as power generation devices, which then preferably provide mechanical energy.

In addition or exclusively, energy can also be supplied by an appropriate design of the interfaces or integration into existing system concepts. The extinguishing device can then preferably be supplied with energy via an external system control. In advantageous further developments, however, at least one energy storage device, such as a (re)chargeable battery or at least one accumulator and/or a capacitor is also provided in such an embodiment, in order to be or remain ready for use at least for short periods, even in the event of a power failure affecting the external energy supply.

In preferred further developments, the dispensing device comprises at least one detection device. The detection device is preferably used to record the changes in a state variable to be monitored. The temperature can, for example, be simply and cost-effectively monitored by a fuse, a bimetal or even a resistance thermometer. The information can be passed on to the control device via an electrical signal. Moreover, it is preferable to detect the chemical composition, moisture or even the conductivity and/or optical properties with appropriate components in order to initiate an extinguishing operation depending on the measurement signal.

In one further preferred embodiment, the detection device is arranged directly on the nozzle device. A particularly compact arrangement of the devices can thus advantageously be achieved. In this case, the detection device can be arranged on the nozzle device such that the release of a flow cross section of the nozzle device is possible at the same time as detection.

The dispensing device advantageously comprises at least one signal device in order to emit at least one audible signal in particular in the case of an extinguishing operation. The extinguishing device can also comprise a signal device for outputting an audible signal. In particular, the signal device can also comprise a siren, horn, flash and/or flashing light.

In one advantageous further development, the dispensing device comprises at least one communication device. In this case, the communication device comprises in particular a communication interface to a house alarm, to a central emergency call, such as the fire brigade, and/or to another previously determined contact person. Communication preferably occurs at least via Bluetooth, GSM, infra-red and/or other radio. The communication device preferably contains appropriate electronic components and circuits for this purpose. The communication device is in particular preferably at least partially contained in the control device or at least partially accommodated therein.

An extinguishing method according to the invention is characterized in that a volume and in particular a volume flow of an extinguishing agent is discharged out of an extinguishing agent supply by means of a pump device through a nozzle device. The method is characterized in that the extinguishing agent is sucked out of a bag device having an at least partially flexible wall, which is in particular only slightly stretchable and/or ideally not stretchable, wherein a bag volume is reduced substantially and in particular precisely by the amount of the discharged volume of the extinguishing agent.

No or only a slight negative pressure is advantageously created in the bag device when the extinguishing agent is dispensed. No propellant and/or compressed gas is used to dispense the extinguishing agent. Moreover, no other mechanical energy storage device such as a system of springs and/or elastically stretchable materials and/or compressed/propellant gases is used. The method is robust and independent of the location and/or orientation of individual devices.

In one preferred embodiment of the method, the extinguishing agent comprises at least two functional components. The functional components are contained in separate bag devices of the extinguishing agent supply. The functional components are mixed in at least one mixing chamber and in particular chemically activated during dispensing. Alternatively, it is also possible that separate extinguishing agents with preferably different chemical properties are contained or are present in the bag devices. These extinguishing agents can be mixed in particular in a mixing chamber as needed. An effective mixing operation can, for example, be set by the flow cross sections of supply lines to the mixing chamber.

Further advantages and features of the present invention result from the exemplary embodiments which are outlined below with reference to the appended figures.

In the figures:

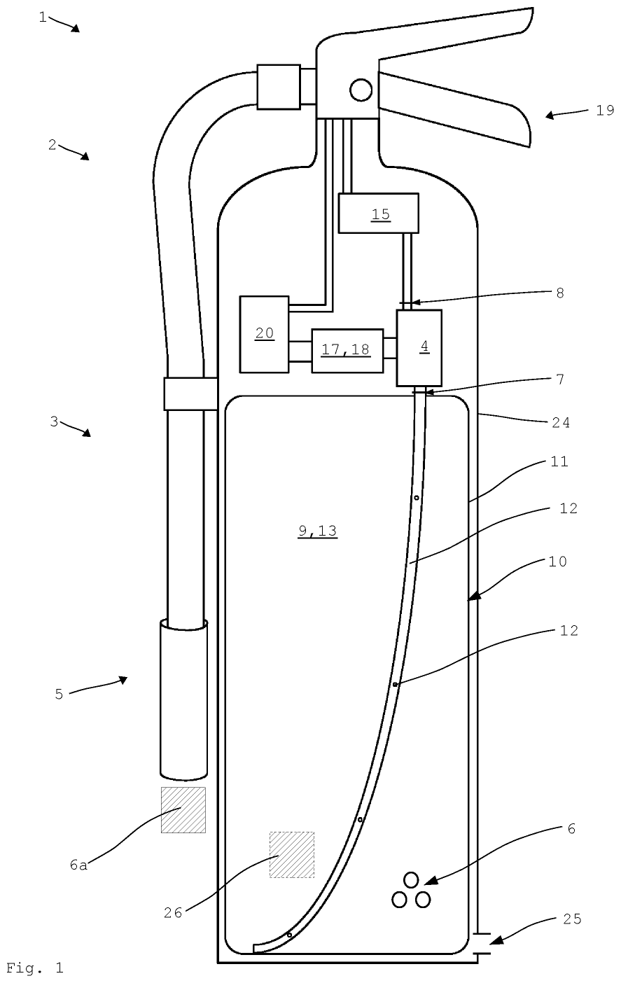

FIG. 1 shows a purely schematic sectional view of an exemplary embodiment of an extinguishing device according to the invention, which is designed as a hand-held fire extinguisher;

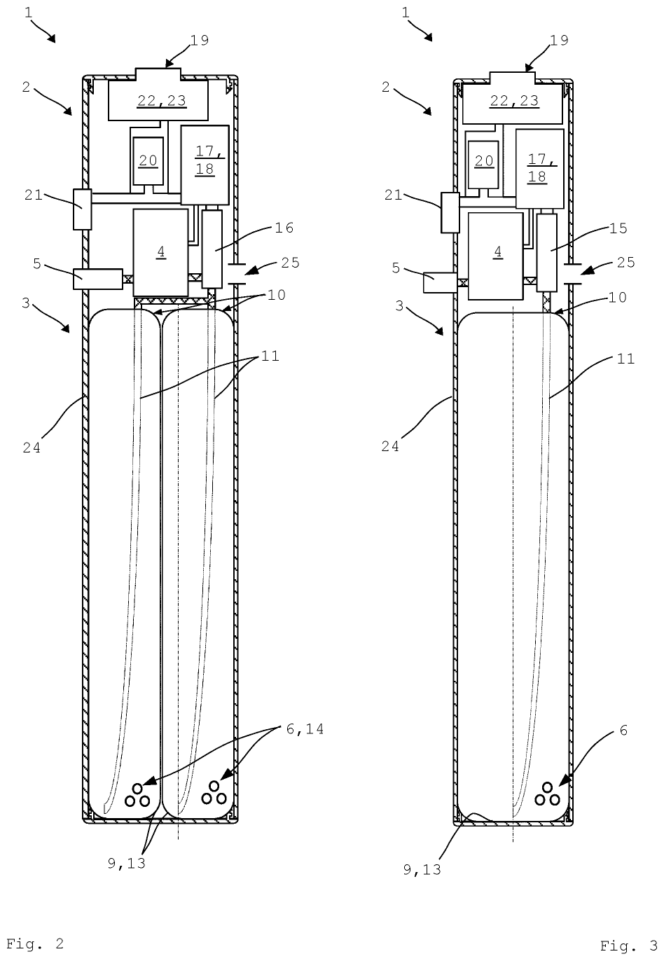

FIG. 2 shows a purely schematic sectional view of a further exemplary embodiment of an extinguishing device according to the invention, which is housed in a cylindrical housing and has two bag devices;

FIG. 3 shows a purely schematic sectional view of a next exemplary embodiment of an extinguishing device according to the invention, which is housed in a cylindrical housing and has one bag device;

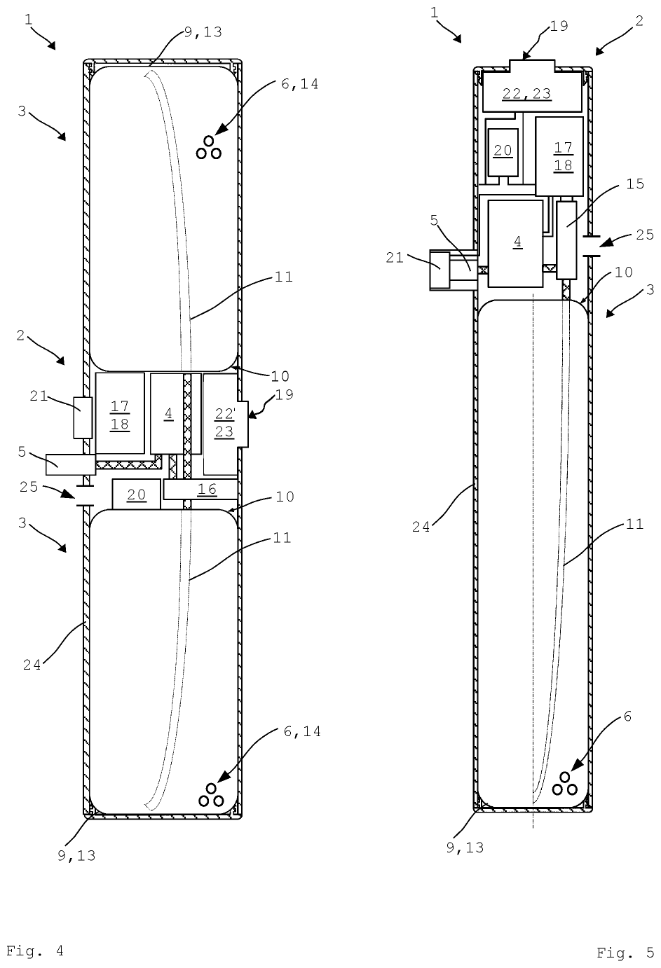

FIG. 4 shows a purely schematic sectional view of another exemplary embodiment of an extinguishing device according to the invention having two bag devices in an alternative arrangement from FIG. 2.

FIG. 5 shows a purely schematic sectional view of a further exemplary embodiment of an extinguishing device according to the invention having a bag device, wherein the detection device is arranged directly on the nozzle device.

FIG. 1 shows a purely schematic sectional view of a first exemplary embodiment of an extinguishing device 1 according to the invention. The housing 24 of the extinguishing device 1 is designed as a housing 24 of a hand-held fire extinguisher here.

The dispensing device 2 is arranged in the upper part of the housing 24 here, whilst the extinguishing agent supply 3 is arranged in the lower part of the housing 24. The extinguishing agent supply 3 comprises a bag device 9 having a flexible wall 10 here. The bag device 9 is designed as a foil bag 13 in the present example. The foil bag 13 is mechanically sealed by an air-tight clamp. In this way, the foil bag 13 can be re-used after an extinguishing operation and also quickly re-filled if necessary.

The nozzle device 5 is formed on the outside of the housing 24 as a tube having a metallic nozzle arranged on the end. The nozzle device 5 can preferably be guided by hand and, for example, directed to a source of fire.

The locking element 11, which is hollow on the inside, is designed here as an intake pipe and has several intake openings 12 here. The extinguishing agent 6 is sucked out of the bag device 9 by the pump device 4 through the intake openings 12. The locking element 12 in particular prevents the sides of the bag from pulling completely together during emptying, which would prevent the discharge of extinguishing agent.

The intake side 7 of the pump device 4 is connected directly to the locking element 11 here. The discharge side 8 of the pump device 4 is operatively connected to the nozzle device 5 via a magnetic valve 15.

The function of the extinguishing device 1 is controlled by the control device 17. The control device 17 comprises several electrical components 18 and electrical circuits 18. The control device 17 also comprises an electrical switching element 19. The pump device 4 can be put into operation and an extinguishing operation initiated with the switching element 19, which is arranged on the outside of the grab handle.

The electrical energy to drive the pump device 4 is provided by the energy storage device 20. The energy storage device 20 is preferably designed as a rechargeable battery or accumulator, which is arranged within the extinguishing device 1.

Alternatively, the electrical energy required to drive the pump device 4 can be provided by a power generation device 20 even directly within the extinguishing device 1. The power generation device 20 could, for example, comprise a solar module and/or a solar panel or even produce thermal and/or electrical energy by a chemical reaction, which differs from the functional principle of a battery.

In an extinguishing operation, the extinguishing agent 6 is sucked out of the bag device 9 by the pump device 4 and discharged through the nozzle device 5. Due to the flexible wall 10 of the bag device 9, the change in volume 26 of the bag device 9 corresponds approximately and in particular exactly to the discharged volume of extinguishing agent 6a.

A ventilation opening 25 is provided so that no negative pressure is created in the housing 24. This compensates for a possible change in pressure in the housing 24. Ideally, there is thus always almost ambient pressure inside the bag device 9.

Thanks to the flexible wall 10 of the bag device 9, the extinguishing device 1 according to the invention functions independently of its position and/or orientation. No compressed or propellant gas is required to dispense the extinguishing agent 6. In this case, the flexible wall 10 is ideally not stretchable such that no energy is mechanically stored in the flexible wall 10 of the bag device 9.

The housing 24 protects the bag device 9 with the flexible wall 10 from damage, for example caused by external force. In addition, the bag device 9, which is designed here as a foil bag 13, is protected by the housing 24 from direct exposure to heat.

FIG. 2 shows an alternative exemplary embodiment of the extinguishing device 1 according to the invention. Here too, the extinguishing device 1 is limited to a purely schematic sectional illustration.

Unlike FIG. 1, the housing 24 has a cylindrical or even square base body. This makes it possible, above all, to achieve a compact design. The housing 24 illustrated here is suitable for installation, for example, on an extractor fan, which is located in the kitchen of a house or mobile home. It is also possible to use it, for example, in the hold of an aeroplane or generally in aviation or even next to gas connections in flats or houses.

In contrast to the exemplary embodiment in FIG. 1, the extinguishing agent supply 3 has two bag devices 9, which are both designed here as foil bags 13. Both bag devices 9 respectively have a locking element 11. The locking elements 11 enable the extinguishing agents to be sucked in directly for dispensing.

The extinguishing device 1 has a mixing chamber 16. The extinguishing agents can be mixed in proportion to one another in the mixing chamber 16 prior to dispensing. The mixed extinguishing agents 6 are then discharged through the nozzle device together or, depending on the application, also individually.

Alternatively, functional components 14 of a single extinguishing agent 6 can be stored within the bag devices 9. During dispensing, the functional components 14 are mixed within the mixing chamber 16, and in particular also chemically activated.

Depending on the design and application, however, different extinguishing agents or even other components can also be present in the different supplies. In this way, different extinguishing agents can be stored, for example, and are discharged depending on the situation identified. An extinguishing agent can be provided as well as a second substance to neutralise the extinguishing agent, which is dispensed after an extinguishing operation.

The switching element 19 is preferably arranged on an end side of the housing 24. In an emergency, an extinguishing operation can thus be initiated manually by a user. In addition, an extinguishing operation can be initiated by the detection device 21. The detection device 21 is preferably designed as a temperature sensor here. If a threshold temperature is exceeded, an electrical signal of the detection device 21 is passed on to the control device 17, which then initiates the extinguishing operation and activates the pump device 4.

In addition, the dispensing device 2 comprises a signal device 22 here. When an extinguishing operation is initiated, the signal device 22 emits a loud alarm sound to indicate the initiation of the extinguishing operation and to warn of the potential source of danger.

Furthermore, the dispensing device 2 comprises a communication device 23. The communication device 23 has a GSM radio module to establish a telephone connection directly to the fire brigade.

FIG. 3 shows an alternative exemplary embodiment of the extinguishing device 1 illustrated in FIG. 2. Here, the extinguishing agent supply 3 only comprises one bag device 9. As a result, the dimensions of the housing 24 can be selected to be smaller.

FIG. 4 too shows an alternative exemplary embodiment of the extinguishing device 1 according to the invention illustrated in FIG. 2. Here, the dispensing device is arranged in the centre of the housing 24 between two bag devices 9 of the extinguishing agent supply 3.

The switching element 19 and the detection device 21 are also arranged in the centre of the housing 24. The extinguishing device 1 can preferably be adapted to the structural conditions of a location by adjusting the design.

FIG. 3 shows a further alternative exemplary embodiment of the extinguishing device 1 according to the invention. Here, the detection device 21 is arranged directly on the nozzle device 5. In this case, the detection device 5 is designed here such that a flow cross section of the nozzle device 5 is covered. The effective flow cross section of the nozzle device 5 is only released once an extinguishing operation is initiated by the detection device 5.

The extinguishing device 1 according to the invention is not limited to the exemplary embodiments shown here. The applicant reserves the right to claim further exemplary embodiments of the invention. In particular, arrangements with 3, 4 or even 5 bag devices are also possible.

### REFERENCE LIST

1 Fire extinguishing device
2 Dispensing device
3 Extinguishing agent supply
4 Pump device
5 Nozzle device
6 Extinguishing agent
61 Discharged extinguishing agent volume
7 Intake side
8 Discharge side
9 Bag device
10 Flexible wall
11 Locking device
12 Intake opening
13 Foil bag
14 Functional component
15 Magnetic valve
16 Mixing chamber
17 Control device
18 Electrical component/circuit
19 Switch
20 Energy storage device, power generation device
21 Detection device
22 Signal device
23 Communication device
24 Housing, hand-held fire extinguisher
25 Ventilation opening
26 Change in bag volume

1. An extinguishing device, comprising: at least one dispensing device and at least one extinguishing agent supply;
wherein the dispensing device comprises at least one pump device and at least one nozzle device in order to dispense at least one extinguishing agent from the extinguishing agent supply; and
the extinguishing agent supply comprises at least one bag device having at least one flexible wall.

2. The extinguishing device according to claim 1, comprising at least one housing, in which the dispensing device and/or the extinguishing agent supply are at least partially arranged.

3. The extinguishing device according to claim 2, wherein the housing has at least one ventilation opening.

4. The extinguishing device according to claim 1, wherein the flexible wall of the bag device is not stretchable or only slightly stretchable.

5. The extinguishing device according to claim 1, wherein an intake side of the pump device is operatively connected to the extinguishing agent supply and wherein a discharge side of the pump device is operatively connected to the nozzle device.

6. The extinguishing device according to claim 1, wherein the bag device comprises at least one foil bag, which is in particular mechanically glued, sealed and/or clamped.

7. The extinguishing device according to claim 1, wherein the extinguishing agent supply comprises two or more bag devices.

8. The extinguishing device according to claim 7, wherein the extinguishing agents contained in the bag devices have at least partially different chemical properties from one another and/or wherein the bag devices contain functional components of an extinguishing agent.

9. The extinguishing device according to claim 1, wherein the bag device comprises at least one locking element, which is in particular assigned to the bag device and/or which is arranged within the bag device, and/or is connected to the bag device.

10. The extinguishing device according to claim 9, wherein the locking element is hollow on the inside and comprises at least one intake opening, which is operatively connected to the pump device.

11. The extinguishing device according to claim 9, wherein the locking element extends over a substantial part of the bag device.

12. The extinguishing device according to claim 1, wherein the dispensing device comprises at least one magnetic valve and/or at least one mixing chamber.

13. The extinguishing device according to claim 1, wherein the dispensing device comprises at least one control device and/or wherein the control device has at least one electrical component and/or at least one electrical circuit.

14. The extinguishing device according to claim 13, wherein the dispensing device comprises at least one energy storage device and/or at least one power generation device.

15. The extinguishing device according to claim 13, wherein the dispensing device comprises at least one detection device.

16. The extinguishing device according to claim 15, wherein the at least one detection device is arranged on the nozzle device.

17. The extinguishing device according to claim 1, wherein the dispensing device comprises at least one signal device in order to emit at least one audible and/or visual signal.

18. The extinguishing device according to claim 1, wherein the dispensing device comprises at least one communication device.

19. An extinguishing method having an extinguishing device according to claim 1, comprising: discharging a volume of an extinguishing agent out of an extinguishing agent supply by means of a pump device through a nozzle device; and
the extinguishing agent is sucked out of a bag device having a flexible wall.

20. The extinguishing method according to claim 19, wherein a bag volume is reduced by the volume of the discharged volume of the extinguishing agent.

21. The extinguishing method according to claim 19, wherein the extinguishing agent comprises at least two functional components, and wherein the functional components are contained in separate bag devices of the extinguishing agent supply and are mixed in at least one mixing chamber during dispensing.
